(19) United States
(12) Patent Application Publication
(10) Pub. No.: US 2025/0150551 A1
(43) Pub. Date: May 8, 2025

(54) INFORMATION PROCESSING SYSTEM, INFORMATION PROCESSING METHOD AND PROGRAM

(71) Applicant: NIPPON TELEGRAPH AND TELEPHONE CORPORATION, Tokyo (JP)

(72) Inventors: Takuya OHARA, Musashino-shi (JP); Kengo SHINTAKU, Musashino-shi (JP); Takuya ODA, Musashino-shi (JP); Katsuaki HIGASHIMORI, Musashino-shi (JP); Fumikazu INUZUKA, Musashino-shi (JP)

(73) Assignee: NIPPON TELEGRAPH AND TELEPHONE CORPORATION, Tokyo (JP)

(21) Appl. No.: 18/294,425

(22) PCT Filed: Aug. 6, 2021
(86) PCT No.: PCT/JP2021/029297

§ 371 Date: Jan. 15, 2025

(51) Int. Cl. H04N 7/035; H04J 99/00

(52) U.S. Cl. CPC H04N 7/035; H04J 99/00

(57) ABSTRACT

One aspect of the present invention is an information processing system including an information apparatus configured to process and transmit a signal, and a reception device configured to process the signal transmitted by the information apparatus and to output the processed signal to a UI device, wherein the information apparatus includes one or a plurality of mapping units configured to generate and map a signal having a frame structure suitable for communication with respect to a signal to be transmitted, a multiplexing unit configured to multiplex the signal mapped by the mapping units through a predetermined method, and a transmission unit configured to transmit the signal multiplexed by the multiplexing unit to the reception device, and the reception device includes a reception unit configured to receive the signal transmitted by the information apparatus, a separation unit configured to separate the multiplexed signal received by the reception unit, and one or a plurality of demapping units configured to generate a data signal from the frame structure.

### TECHNICAL FIELD

The present invention relates to technology of an information processing system, an information processing method, and a program.

### BACKGROUND ART

User interface (UI) devices such as display devices, keyboards, mice, and operation controllers are connected to computers, game consoles (hereinafter referred to as “information apparatuses”), and the like, and operated. In an information apparatus, a UI device at the hand of a user is connected to the information apparatus installed at the hand of the user in a wired or wireless manner. As a device that allows a UI device to be installed at a location physically separated from an information apparatus, an extension device (for example, KVM extender (KVM=Keyboard, Video, Mouse)) is used (refer to Non Patent Document 1, for example). For example, as shown in FIG. 7, a UI device (for example, a display device 901) at the hand is connected to an extension device 902 and is connected to an information apparatus 904 in which an opposite extension device 903 is installed via a network NW. The network NW has, for example, a switching function and a cross-connecting function. FIG. 7 is a diagram showing an example of connection between a UI device and an information apparatus using an extender in the prior art. In addition, other conventional techniques for allowing a UI device and an information apparatus to be installed at physically separated locations include a remote desktop function (refer to Non Patent Document 2, for example).

### CITATION LIST

### Non Patent Document

Non Patent Document 1: Monitoring and control of access to PC! Dual-link DVI-DIP-KVM extender, new release, 2020.7.6, The Daily Industrial News, [Internet retrieval] <https://www.nikkan.co.jp/releases/view/110893> (retrieved on 2021.7.26)

Non Patent Document 2: Nishijima Takamichi, Nakai Yuto, Ohsaki Hiroyuki, et al., “On the Impact of Network Environment on Remote Desktop Protocols,” IEICE Technical Report CQ2012-21 (2012-7), Electronic Information Communication Society, 2012, p23-28

### SUMMARY OF INVENTION

### Technical Problem

However, in the case of connecting an information apparatus and a UI device for a plurality of users, it is necessary to provide extension devices corresponding to the number of users on a transmitting side and a receiving side, respectively, as shown in FIG. 8. FIG. 8 is a diagram showing an example of a configuration using extenders in the case of a plurality of users in the prior art. When video signals are transmitted, in particular, there is a problem that wiring and an extension device need to be prepared for each video signal standard.

In view of the above circumstances, an object of the present invention is to provide a technique capable of connecting an information apparatus and a UI device for a plurality of users without using an extension device for each UI signal standard.

### Solution to Problem

One aspect of the present invention is an information processing system including: an information apparatus configured to process and transmit a signal; and a reception device configured to process the signal transmitted by the information apparatus and to output the processed signal to a UI device, wherein the information apparatus includes one or a plurality of mapping units configured to generate and map a signal having a frame structure suitable for communication with respect to a signal to be transmitted, a multiplexing unit configured to multiplex the signal mapped by the mapping units through a predetermined method, and a transmission unit configured to transmit the signal multiplexed by the multiplexing unit to the reception device, and the reception device includes a reception unit configured to receive the signal transmitted by the information apparatus, a separation unit configured to separate the multiplexed signal received by the reception unit, and one or a plurality of demapping units configured to generate a data signal from the frame structure.

One aspect of the present invention is an information processing method in an information processing system including an information apparatus configured to process and transmit a signal and a reception device configured to process the signal transmitted by the information apparatus and to output the processed signal to a UI device, the information processing method including: by the information apparatus, generating and mapping a signal having a frame structure suitable for communication with respect to a signal to be transmitted, multiplexing the mapped signal through a predetermined method, and transmitting the multiplexed signal; and by the reception device, receiving the signal transmitted by the information apparatus, separating the received multiplexed signal, and generating a data signal from the frame structure.

One aspect of the present invention is a program in an information processing system including an information apparatus configured to process and transmit a signal and a reception device configured to process the signal transmitted by the information apparatus and to output the processed signal to a UI device, the program causing a computer of the information apparatus to generate and map a signal having a frame structure suitable for communication with respect to a signal to be transmitted, to multiplex the mapped signal through a predetermined method, and to transmit the multiplexed signal and causing a computer of the reception device to receive the signal transmitted by the information apparatus, to separate the received multiplexed signal, and to generate a data signal from the frame structure. Advantageous Effects of Invention

According to the present invention, it is possible to connect an information apparatus and a UI device for a plurality of users without using an extension device for each UI signal standard.

### BRIEF DESCRIPTION OF DRAWINGS

FIG. 1 A diagram showing an example of a configuration of an information processing system according to an embodiment.

FIG. 2 A diagram showing an example of a configuration of an information apparatus according to an embodiment.

FIG. 3 A diagram showing an example of a configuration of a video signal reception device according to an embodiment.

FIG. 4 A flowchart of a processing procedure performed by the information apparatus according to an embodiment.

FIG. 5 A flowchart of a processing procedure performed by the video signal reception device according to an embodiment.

FIG. 6 A diagram showing an example of a configuration of an information apparatus of the prior art.

FIG. 7 A diagram showing an example of connection between a UI device and an information apparatus using an extender in the prior art.

FIG. 8 A diagram showing an example of a configuration using extenders in the case of a plurality of users in the prior art.

### DESCRIPTION OF EMBODIMENTS

Embodiments of the present invention will be described in detail with reference to the drawings.

### Example of Configuration of Information Processing System

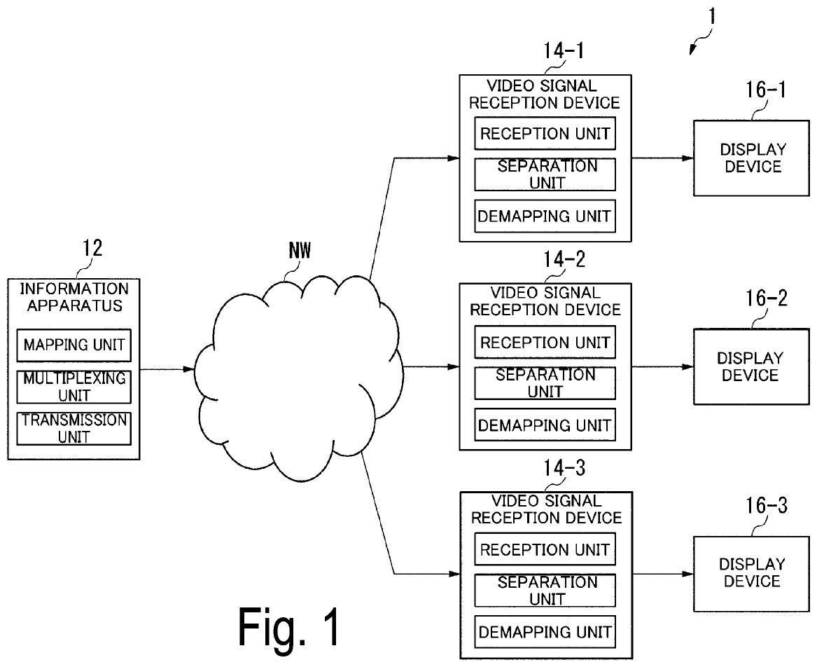

FIG. 1 is a diagram showing an example of a configuration of an information processing system according to the present embodiment. As shown in FIG. 1, the information processing system 1 includes an information apparatus 12, a video signal reception device 14 (14-1, 14-2, and 14-3), and a display device 16 (16-1, 16-2, and 16-3) (reception device). The information apparatus 12 and the video signal reception device 14 are connected to each other via a network NW. Although three video signal reception devices 14 and three display devices 16 are illustrated in the example shown in FIG. 1, the number of video signal reception devices 14 and the display devices 16 may be two or four or more. Further, although the display device 16 is used as an example of a UI device in FIG. 1, UI devices may include a keyboard, a mouse, an operation controller, and the like.

In the network NW, at least one of an electrical cross-connect or an optical cross-connect may be provided. The electrical cross-connect is, for example, an optical-channel data unit (ODU) cross-connect. The optical cross-connect is, for example, a reconfigurable optical add/drop multiplexer (ROADM).

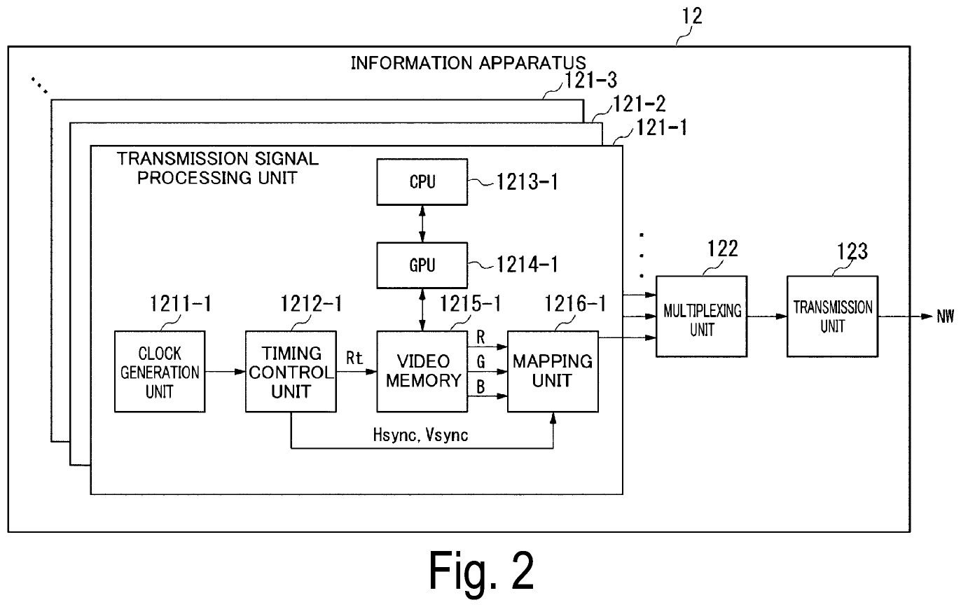

The information apparatus 12 includes, for example, a computer, a game device, a portable terminal, a smartphone, a tablet terminal, a television, a set-top box, a wearable device, and the like. As will be described later, the information apparatus 12 includes one or more mapping units, a multiplexing unit, and a transmission unit. In addition, the information apparatus 12 includes a central processing unit (CPU) and a graphic processing unit (GPU), as will be described later. Further, the information apparatus 12 transmits a signal obtained by mapping RGB (Red, Green, Blue) data that does not conform to specific video signal standards to a frame structure suitable for communication to the plurality of video signal reception devices 14 via the network NW. The video signal standards are, for example, high-definition multimedia interface (HDMI) (registered trademark), DisplayPort, and the like. A configuration example and a processing example of the information apparatus 12 will be described later with reference to FIG. 2.

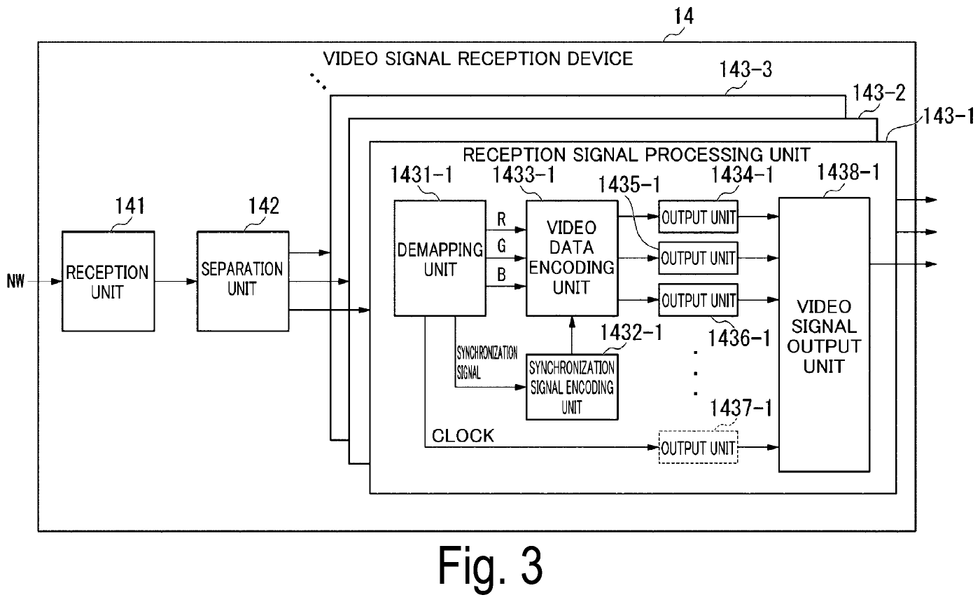

As will be described later, the video signal reception device 14 includes a reception unit, a separation unit, and one or more demapping units. The video signal reception device 14 separates the signal received from the information apparatus 12, for example, by an ODU, generates RGB data, a synchronizing signal, and a clock signal as necessary, and displays a signal conforming to the video signal standards on the display device 16. A configuration example and a processing example of the video signal reception device 14 will be described later with reference to FIG. 3.

The display device 16 is, for example, a liquid crystal display device, an organic electroluminescence (EL) image display device, or the like.

Configuration and Operation Example of Information Apparatus

FIG. 2 is a diagram showing an example of a configuration of the information apparatus according to the present embodiment. As shown in FIG. 2, the information apparatus 12 includes, for example, a transmission signal processing unit 121 (121-1, 121-2, 121-3, . . . ), a multiplexing unit 122, and a transmission unit 123. The transmission signal processing unit 121 includes, for example, a clock generation unit 1211 (1211-1, 1211-2, 1211-3, . . . ), a timing control unit 1212 (1212-1, 1212-2, 1212-3, . . . ), a CPU 1213 (1213-1, 1213-2, 1213-3, . . . ), a GPU 1214 (1214-1, 1214-2, 1214-3, . . . ), a video memory 1215 (1215-1, 1215-2, 1215-3, . . . ), and a mapping unit 1216 (1216-1, 1212-6, 1216-3, . . . ). All or some transmission signal processing units 121 may be constructed in a virtual environment, for example. For example, one CPU 1213 and one GPU 1214 may be physically provided and may be virtualized to be seen as a plurality of CPUs and GPU. Further, the information apparatus 12 may physically include a plurality of mapping units 1216 and the like.

The clock generation unit 1211 generates a clock signal and outputs the clock signal to the timing control unit 1212.

The timing control unit 1212 generates a signal for controlling various timings of video data using the clock signal output by the clock generation unit 1211. The timing control unit 1212 outputs a read timing Rt to the video memory. The timing control unit 1212 outputs a horizontal synchronization signal (Hsync) and a vertical synchronization signal (Vsync) to the mapping unit 1216.

The CPU 1213 and the GPU 1214 exchange commands and data.

The GPU 1214 writes video data in the video memory 1215 for drawing on a screen. The video memory 1215 is, for example, a dual port random access memory (RAM). The video memory 1215 outputs RGB data to the mapping unit 1216.

The mapping unit 1216 maps (agnostic maps) RGB data that does not conform to a specific video signal standard to a frame structure suitable for communication as it is. The frame structure is, for example, an optical transport network (OTN). Each mapping unit 1216 outputs the mapped signal to the multiplexing unit 122. The plurality of mapping units 1216 may be present as physical bodies or may be realized virtually.

The multiplexing unit 122 performs ODU multiplexing processing in an OTN, for example, on signals input from the plurality of mapping units 1216. Accordingly, in the present embodiment, multiplexing processing is performed in the information apparatus 12. The multiplexing unit 122 inputs the multiplexed signals to the transmission unit 123 such that the signals are transmitted to the outside of the information apparatus 12.

The transmission unit 123 transmits the signals input from the multiplexing unit 122 to the plurality of video signal reception devices 14 via the network NW. The signals from the transmission unit 123 are, for example, OTU signals in the OTN.

Here, processing performed by the information apparatus 12 is further described.

Data corresponding to each dot of a screen, for example, RGB, for screen display is stored in the video memory 1215. The information processing system 1 updates display contents of the display device 16 by continuously rewriting the data stored in the video memory 1215. In the video memory 1215, the correspondence relationship between addresses on the video memory 1215 and dot positions on the screen has been determined.

The information apparatus 12 stores such RGB data in an optical-channel payload unit (OPU) payload area defined by the OTN, for example. The information apparatus 12 uses an OPU having a payload area greater than an RGB data transmission rate from the video memory 1215. Since the clock signal of the RGB data and the clock signal of the OPU are generally independent, the information apparatus 12 matches the RGB data with the capacity of the OPU payload by performing stuffing processing or idle signal insertion on the RGB data and then stores the RGB data in the OPU payload.

Although an example of using an OPU having a payload area greater than the RGB data transmission rate from the video memory 1215 has been described, the present invention is not limited thereto. The information apparatus 12 may reduce a required payload area by performing compression processing on the RGB data.

The configuration of the information apparatus 12 illustrated in FIG. 2 is an example, and the present invention is not limited thereto.

Further, the output of the information apparatus 12 is cross-connected to the video signal reception device 14 through the network NW.

### Examples of Configuration and Operation of Video Signal Reception Device

FIG. 3 is a diagram showing an example of a configuration of the video signal reception device according to the present embodiment. As shown in FIG. 3, the video signal reception device 14 includes, for example, a reception unit 141, a separation unit 142, and a reception signal processing unit 143 (143-1, 143-2, 143-3, . . . ).

The reception signal processing unit 143 includes a demapping unit 1431 (1431-1, 1431-2, 1431-3, . . . ), a synchronization signal encoding unit 1432 (1432-1, 1432-2, 1432-3, . . . ), a video data encoding unit 1433 (1433-1, 1433-2, 1433-3, . . . ), an output unit 1434 (1434-1, 1434-2, 1434-3, . . . ) (data encoding unit), an output unit 1435 (1435-1, 1435-2, 1435-3, . . . ), an output unit 1436 (1436-1, 1436-2, 1436-3, . . . ), an output unit 1437 (1437-1, 1437-2, 1437-3, . . . ), and a video signal output unit 1438 (1438-1, 1438-2, 1438-3, . . . ).

The reception unit 141 receives a signal (for example, an OTU signal) transmitted by the information apparatus 12 and outputs the received signal to the separation unit 142.

The separation unit 142 performs, for example, ODU separation processing on the signal (for example, an OTU signal) output from the reception unit 141. The separation unit 142 outputs the separated signal to one or a plurality of demapping units 1431.

The demapping unit 1431 generates RGB data and a synchronization signal from the frame structure of the signal output from the separation unit 142. The demapping unit 1431 generates a clock signal when the video signal standard is, for example, HDMI (transition minimized differential signaling (TMDS)). The demapping unit 1431 outputs the RGB data to the video data encoding unit 1433 and outputs the synchronization signal to the synchronization signal encoding unit 1432. When the video signal standard is, for example, HDMI, the demapping unit 1431 outputs the clock signal to the output unit 1437.

The synchronization signal encoding unit 1432 encodes the synchronization signal from the demapping unit 1431 and outputs the encoded synchronization signal to the video data encoding unit 1433.

The video data encoding unit 1433 generates a signal conforming to the video signal standard using the RGB data from the demapping unit 1431 and the synchronizing signal from the synchronization signal encoding unit and inputs the generated signal to the output units 1434 to 1436. In the present embodiment, the video data encoding unit 1433 encodes the video signal into a desired video signal standard for each user. As described above, the video signal standard is, for example, HDMI (TMDS), fixed rate link (FRL), DisplayPort (bit distribution), or the like.

The output units 1434 to 1437 output the signal output from the demapping unit 1431 or the signal output from the video data encoding unit 1433 to the video signal output unit 1438. The output units 1434 to 1437 performs serialization processing on the signals, controls the signals to a specified voltage, and input them to the video signal output unit. The specified voltage is, for example, low voltage differential signaling (LVDS). The video signal output unit 1438 outputs a video signal conforming to a video signal standard for each user to the display devices 16-1 to 16-3.

The configuration of the video signal reception device 14 illustrated in FIG. 3 is an example and the present invention is not limited thereto.

For example, the video signal reception device 14 may include, for example, a compression unit, and the compression unit is, for example, VESA display stream compression (DSC), VESA display compression for mobile (VDC-M), MPEG, or the like.

Further, the video signal reception device 14 may not include the separation unit 142 if it is cross-connected in the network NW and signals become one system.

The information apparatus 12 and the video signal reception device 14 may be configured using a processor such as a central processing unit (CPU) and a memory. The information apparatus 12 may serve as the transmission signal processing unit 121, the multiplexing unit 122, and the transmission unit 123 by the processor executing a program. In addition, the video signal reception device 14 may serve as the reception unit 141, the separation unit 142, and the reception signal processing unit 143 by the processor executing the program. All of some functions of the information apparatus 12 and the video signal reception device 14 may be realized using hardware such as an application specific integrated circuit (ASIC), a programmable logic device (PLD), or a field programmable gate array (FPGA). The aforementioned program may be recorded on a computer-readable recording medium. The computer-readable recording medium is, for example, a storage device such as a portable medium such as a flexible disc, a magneto-optical disc, a ROM, a CD-ROM, or a semiconductor storage device (e.g., solid state drive (SSD)), or a hard disk or a semiconductor storage device built in a computer system. The aforementioned program may be transmitted via a telecommunication line.

### Processing Procedure of Information Processing System

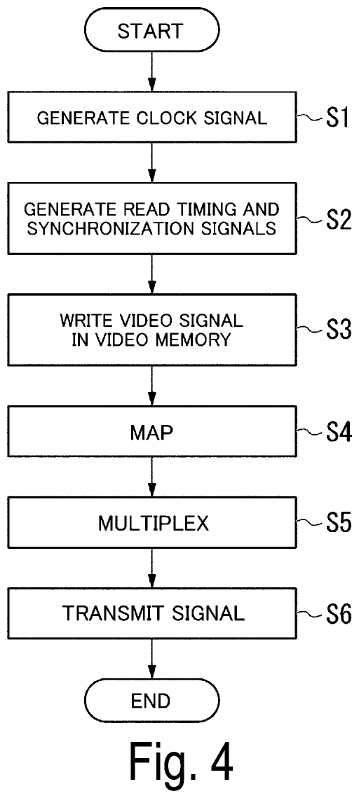

Next, a processing procedure of the information processing system will be described. First, an example of a processing procedure performed by the information apparatus 12 will be described. FIG. 4 is a flowchart of the processing procedure performed by the information apparatus according to the present embodiment.

(Step S1) The clock generation unit 1211 generates a clock signal.

(Step S2) The timing control unit 1212 generates a read timing and synchronization signals (horizontal synchronization signal and vertical synchronization signal) using the clock signal output from the clock generation unit 1211.

(Step S3) The GPU 1214 writes video data in the video memory 1215 for drawing on a screen.

(Step S4) The mapping unit 1216 maps, for example, RGB data to a frame structure suitable for communication. Each transmission signal processing unit 121 performs processing of steps S1 to S4.

(Step S5) The multiplexing unit 122 multiplexes signals input from the plurality of mapping units 1216 by a predetermined method (for example, ODU multiplexing in OTN).

(Step S6) The transmission unit 123 transmits the signal (for example, an OTU signal) input from the multiplexing unit 122 to the plurality of video signal reception devices 14 via the network NW.

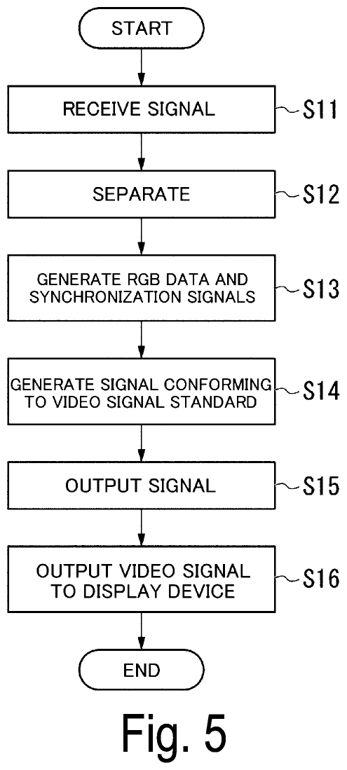

Next, an example of a processing procedure performed by the video signal reception device 14 will be described. FIG. 5 is a flowchart of the processing procedure performed by the video signal reception device according to the present embodiment.

(Step S11) The reception unit 141 receives a signal (for example, an OTU signal) transmitted by the information apparatus 12.

(Step S12) The separation unit 142 performs, for example, ODU separation processing on the signal (for example, OTU signal) output from the reception unit 141.

(Step S13) The demapping unit 1431 generates RGB data and a synchronization signal from the frame structure of the signal output from the separation unit 142 (performs demapping).

(Step S14) The video data encoding unit 1433 generates a signal conforming to a video signal standard using the RGB data from the demapping unit 1431 and the synchronization signal from the synchronization signal encoding unit.

(Step S15) The output units 1434 to 1437 output the signal output from the demapping unit 1431 or the signal output from the video data encoding unit 1433 to the video signal output unit 1438.

(Step S16) The video signal output unit 1438 outputs a video signal conforming to a video signal standard for each user to the display device 16 for each user.

Each reception signal processing unit 143 performs processing of steps S13 to S16.

### Comparison with Prior Art

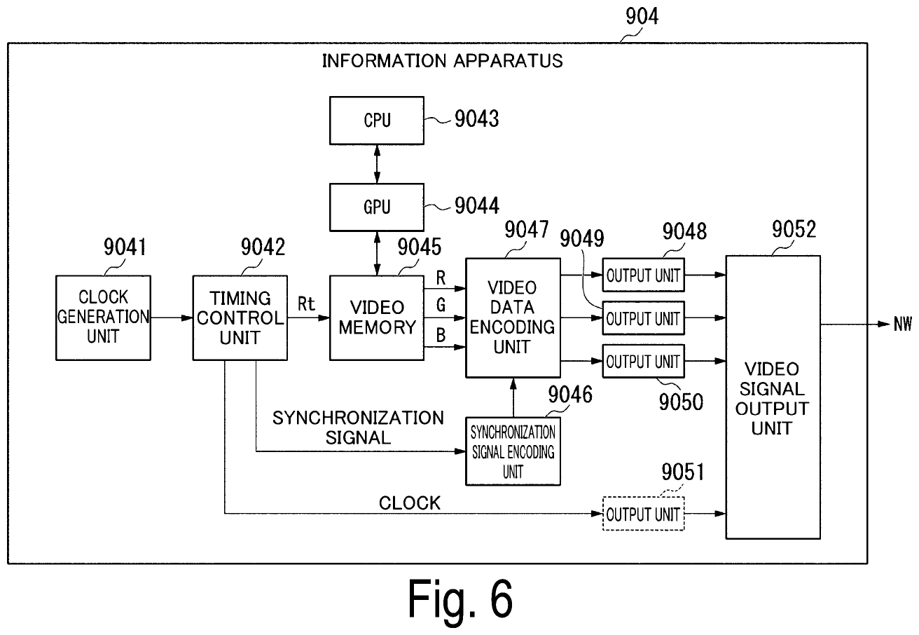

Here, the present embodiment is compared with the prior art. FIG. 6 is a diagram showing an example of a configuration of an information apparatus of the prior art. As shown in FIG. 6, the information apparatus 904 of the prior art includes a clock generation unit 9041, a timing control unit 9042, a CPU 9043, a GPU 9044, a video memory 9045, a synchronization signal encoding unit 9046, a video data encoding unit 9047, output units 9048 to 9051, and a video signal output unit 9052.

The clock generation unit 9041 generates a clock signal. The timing control unit 9042 generates a signal for controlling various timings of video data using the clock signal.

The timing control unit 9042 outputs a read timing to the video memory 9045, outputs synchronization signals (horizontal synchronization signal and vertical synchronization signal) to the synchronization signal encoding unit 9046, and outputs clock information to the output unit 9051 as necessary.

The CPU 9043 and the GPU 9044 are connected and exchange commands and data. The GPU 9044 writes video data in the video memory 9045 for drawing on a screen.

The video memory 9045 outputs RGB data to the video data encoding unit 9047 in accordance with the read timing. The synchronization signal encoding unit 9046 encodes the synchronization signals and outputs the synchronization signals to the video data encoding unit 9047.

The video data encoding unit 9047 generates a signal conforming to a video signal standard on the basis of the RGB data from the video memory 9045 and the synchronization signals from the synchronization signal encoding unit 9046 and outputs the generated video signal to output units 9048 to 9050.

The output units 9048 to 9051 output the signal output from the timing control unit 9042 or the signal output from the video data encoding unit 9047 to the video signal output unit 9052. The output units 9048 to 9051 perform serialization processing on the signals, control the signals to a specified voltage, and input them to the video signal output unit. The specified voltage is, for example, LVDS.

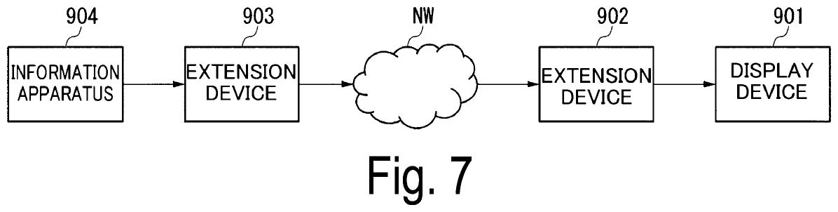

The video signal output unit 9052 outputs a signal to the outside of the information apparatus 904 via a specified connector. The specified connector is, for example, a connector of HDMI or DisplayPort. The output signal is transmitted to the extension device 902 via the extension device 903 and the network NW as shown in FIG. 7, for example, and displayed on the display device 901.

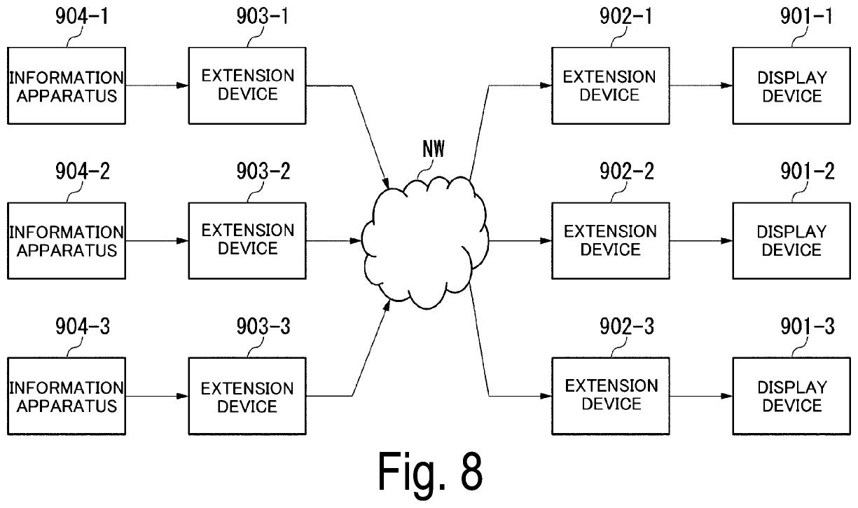

In this manner, the video data encoding unit 9047 generates a signal conforming to a specific video signal standard. Further, in the prior art, it is necessary to provide extension devices corresponding to the number of users on the transmitting side and the receiving side, as shown in FIG. 8, and wirings corresponding to the number of users is required.

On the other hand, in the present embodiment, RGB data that does not conform to a specific video signal standard is mapped as it is to a frame structure suitable for communication, and UI signals (for example, video signals) of a plurality of users are collectively transmitted from the information apparatus 12. Therefore, according to the present embodiment, UI signals of a plurality of users can be collectively transmitted in a form independent of a signal standard in the information apparatus 12, and thus installation of extension devices for signal standards corresponding to the number of users on the side of the information apparatus 12 becomes unnecessary, reducing the cost of equipment.

### Modified Examples

Although HDMI and DisplayPort have been described as an example of video signals in the above-described example, video signals of other video signal standards may be used. Further, although an example in which the video memory 1215 outputs RGB signals to the mapping unit 1216 in the transmission signal processing unit 121 has been described in the above-described example, the present invention is not limited thereto. A signal output from the video memory 1215 may be YCbCr or the like. In this case, a signal output from the demapping unit 1431 to the video data encoding unit 1433 may be YCbCr or the like in the reception signal processing unit 143.

Further, although an example in which the information apparatus 12 transmits an OTU signal has been described in the above-described example, signals of other standards may be transmitted. In this case, the information apparatus 12 performs mapping according to a transmission signal, and the video signal reception device 14 performs demapping according to the transmitted signal.

Further, although a video signal is used as an example of a UI signal in the above-described example, the present invention is not limited thereto. The information apparatus 12 can collectively transmit UI signals of a plurality of users by the same method as the above-described method for operation signals or the like. Furthermore, the information processing system 1 may transmit and receive at least one of a video signal or a UI signal such as an operation signal.

Although the embodiments of the present invention have been described in detail with reference to the drawings, a specific configuration is not limited to this embodiment, and design within the scope of the gist of the present invention, and the like are included.

### Industrial Applicability

The present invention is applicable to, for example, a gaming system, an eSports system, a remote desktop system, an information apparatus rental system, and the like.

### REFERENCE SIGNS LIST

12 Information processing system,
12 Information apparatus
14 (14-1, 14-2, 14-3) Video signal reception device
16 (16-1, 16-2, 16-3) Display device
NW Network
121 (121-1, 121-2, 121-3, . . . ) Transmission signal processing unit
122 Multiplexing unit
123 Transmission unit
1211 (1211-1, 1211-2, 1211-3, . . . ) Clock generation unit
1212 (1212-1, 1212-2, 1212-3, . . . ) Timing control unit
1213 (1213-1, 1213-2,1213-3, . . . ) CPU
1214 (1214-1, 1214-2, 1214-3, . . . ) GPU
1215 (1215-1, 1215-2, 1215-3, . . . ) Video memory
1216 (1216-1, 1212-6, 1216-3, . . . ) Mapping unit
141 Reception unit
142 Separation unit
143 (143-1, 143-2, 14303, . . . ) Reception signal processing unit
1431 (1431-1, 1431-2, 1431-3, . . . ) Demapping unit
1432 (1432-1, 1432-2, 1432-3, . . . ) Synchronization signal encoding unit
1433 (1433-1, 1433-2, 1433-3, . . . ) Video data encoding unit
1434 (1434-1, 1434-2, 1434-3, . . . ) Output unit
1435 (1435-1, 1435-2, 1435-3, . . . ) Output unit
1436 (1436-1, 1436-2, 1436-3, . . . ) Output unit
1437 (1437-1, 1437-2, 1437-3, . . . ) Output unit
1438 (1438-1, 1438-2, 1438-3, . . . ) Video signal output unit

1. An information processing system comprising:
an information apparatus configured to process and transmit a signal; and
a reception device configured to process the signal transmitted by the information apparatus and to output the processed signal to a UI device,
wherein
the information apparatus comprises one or a plurality of mapping units configured to generate and map a signal having a frame structure suitable for communication with respect to a signal to be transmitted, a multiplexing unit configured to multiplex the signal mapped by the mapping units through a predetermined method, and a transmission unit configured to transmit the signal multiplexed by the multiplexing unit to the reception device, and
the reception device comprises a reception unit configured to receive the signal transmitted by the information apparatus, a separation unit configured to separate the multiplexed signal received by the reception unit, and one or a plurality of demapping units configured to generate a data signal from the frame structure.

2. The information processing system according to claim 1, wherein the reception device further comprises a data encoding unit configured to convert the signal into a signal conforming to a signal standard of a UI device connected to the reception device.

3. The information processing system according to claim 2, wherein the signal is a video signal,
the mapping units map the video signal to a frame structure for communication in the form of RGB data, and
the data encoding unit outputs a signal of a specific video signal standard on the basis of data generated by the demapping units.

4. The information processing system according to any one of claims 1 to 3, wherein the information apparatus and the reception device are connected via a network, and
the network includes at least one of an electrical cross-connect or an optical cross-connect.

5. The information processing system according to any one of claims 1 to 4, wherein the signal is at least one of a video signal or an operation signal.

6. An information processing method in an information processing system comprising an information apparatus configured to process and transmit a signal and a reception device configured to process the signal transmitted by the information apparatus and to output the processed signal to a UI device, the information processing method comprising:
by the information apparatus, generating and mapping a signal having a frame structure suitable for communication with respect to a signal to be transmitted, multiplexing the mapped signal through a predetermined method, and transmitting the multiplexed signal; and
by the reception device, receiving the signal transmitted by the information apparatus, separating the received multiplexed signal, and generating a data signal from the frame structure.

7. A program in an information processing system comprising an information apparatus configured to process and transmit a signal and a reception device configured to process the signal transmitted by the information apparatus and to output the processed signal to a UI device,
the program causing a computer of the information apparatus to generate and map a signal having a frame structure suitable for communication with respect to a signal to be transmitted, to multiplex the mapped signal through a predetermined method, and to transmit the multiplexed signal, and
causing a computer of the reception device to receive the signal transmitted by the information apparatus, to separate the received multiplexed signal, and to generate a data signal from the frame structure.
